(19) United States
(12) Patent Application Publication
(10) Pub. No.: US 2026/0103148 A1
(43) Pub. Date: Apr. 16, 2026

(54) VEHICLE ACCESSORIES AND RELATED METHODS

(71) Applicant: IP MILL HOLDINGS LLC, Los Angeles, CA (US)

(72) Inventor: Filip Postolek, Simi Valley, CA (US)

(21) Appl. No.: 19/116,692

(22) PCT Filed: Oct. 24, 2023
(86) PCT No.: PCT/US2023/077595

§ 371 Date: Mar. 28, 2025

Related U.S. Application Data
(60) Provisional application No. 63/418,667, filed on Oct. 24, 2022.
(60) Provisional application No. 63/420,852, filed on Oct. 31, 2022.

(51) Int. Cl. B60R 7/04; B60R 7/08

(52) U.S. Cl. CPC B60R 7/04; B60R 7/08

(57) ABSTRACT

Vehicle accessories include a storage receptacle. In one form, the storage receptacle includes a front panel and. a rear panel pivotally coupled to the front panel by a hinge and forming an internal cavity in a closed condition. The receptacle may include a Modular Lightweight Load-carrying Equipment (MOLLE) system, and may be used as a headliner for an interior of a vehicle roof. A grab handle assembly for a portion of a vehicle is also disclosed as another form of vehicle accessory, along with a storage receptacle in the form of a cover for covering a vehicle wheel. Related methods are also disclosed.

This application claims the benefit of U.S. Provisional Patent Application Ser. No. 63/418667, filed Oct. 24, 2022, and U.S. Provisional Patent Application Ser. No. 63/420852, filed Oct. 31, 2022, the disclosures of which are incorporated herein by reference.

### TECHNICAL FIELD

The present disclosure generally relates to vehicle accessories, some of which include a Modular Lightweight Load-carrying Equipment (MOLLE) system, and thus may serve as storage receptacles.

### BACKGROUND

Modular Lightweight Load-carrying Equipment (MOLLE) system refers to the current generation of load-bearing equipment and backpacks used by a number of NATO armed forces including the United States Army. Conventional MOLLE systems employ Pouch Attachment Ladder System (PALS) webbing as rows of heavy-duty nylon stitched onto the military backpacks, bags, vests and similar sewn products to allow for the attachment of various compatible pouches and accessories such as various sizes of magazines, knives, water bottle etc. This method of attachment has become a de facto standard for modular tactical gear.

The present disclosure discloses various vehicle accessories, including storage receptacles, headliners, grab handles, and related methods. Certain of these accessories are designed to increase the durability of the MOLLE system, and also allow such to be used on hard objects, such as thermoformed/molded backpacks, bags, vehicle panels, containers etc.

### SUMMARY

According to a first aspect of the disclosure, a storage receptacle for storing one or more objects in a vehicle. The receptacle includes a front panel having a front core defining a plurality of vertical canals extending generally in parallel. A plurality of cross members are coupled to the front core and intersecting the plurality of vertical canals to form a grid. A rear panel is connected to the front panel by a hinge and movable from an open condition to a closed condition forming an internal cavity for receiving the one or more objects. A closure is also provided for securing the front panel to the rear panel to retain the one or more objects in the internal cavity in the closed position.

In one embodiment, the rear panel comprises a rear core defining a pair of channels and a plurality of protrusions, the pair of channels being positioned between adjacent pairs of the plurality of protrusions. The rear panel further comprises fasteners for securing the storage receptacle to a portion of the vehicle. The front core further defines a plurality of depressions that intersect the plurality of vertical canals, the plurality of cross members being positioned within the plurality of depressions. The plurality of depressions have a depth that is less than a depth of the vertical canals.

The plurality of cross members comprise a plurality of external cross members connected to an external surface of the front panel, and a plurality of internal cross members coupled to an internal surface of the front panel. The internal cross members are positioned on the internal surface such that attachment hardware extends through the external cross members, the front core, and the internal cross members to couple each of the external cross members, the front core, and the internal cross members together.

In one embodiment, the closure comprises a coupler coupled to a periphery of the front panel and a receiver coupled to a periphery of the rear panel, the coupler adapted to be received by the receiver to selectively secure the front panel to the rear panel. In one example, the closure is a zipper.

The receptacle may further comprise a handle coupled to one of the front panel and the rear panel. A length for each cross member greater than a width of all vertical canals combined, and a length for each of the plurality of vertical canals is greater than a width of all cross members combined. The rear panel is harder than the front panel. The distance between each vertical canal is the same. A headliner may comprise the storage receptacle.

According to another aspect of the disclosure, a vehicle including an interior roof comprises a headliner. The headliner is adapted for storing one or more objects. A connector is also provided for removably connecting the headliner to the interior roof of the vehicle.

In one embodiment, the headliner includes a plurality of vertical canals extending generally in parallel, and a plurality of cross members coupled to the headliner, the plurality of cross members intersecting the plurality of vertical canals to form a grid. The headliner may further comprise a front panel including the plurality of vertical canals, a front core coupled to the plurality of cross members, and a rear panel pivotally coupled to the front panel by a hinge. The rear panel is configured to be selectively coupled to the front panel to define an internal cavity.

In this or other embodiments, the rear panel comprises a rear core defining a pair of channels and a plurality of protrusions. The pair of channels are positioned between adjacent pairs of the plurality of protrusions. The connector may be located on at least one of the pair of channels and the plurality of protrusions.

The front core may further define a plurality of depressions that intersect the plurality of vertical canals. The plurality of cross members may be positioned within the plurality of depressions. The plurality of depressions may have a depth that is less than a depth of the vertical canals.

The plurality of cross members may comprise a plurality of external cross members coupled to an external surface of the front panel. A plurality of internal cross members may be coupled to an internal surface of the front panel. The internal cross members may be positioned on the internal surface. Fasteners may extend through the external cross members, the front core, and the internal cross members to couple each of the external cross members, the front core, and the internal cross members together.

A closure may also comprise a coupler coupled to a periphery of the front panel and a receiver coupled to a periphery of the rear panel. The coupler is receivable by the receiver to selectively couple the front panel to the rear panel. The closure may be a zipper. A handle may also be coupled to one of the front panel and the rear panel.

A length of each cross member greater than a width of all vertical canals combined, and a length for each of the plurality of vertical canals is greater than a width of all cross members combined. The rear panel may be harder or more rigid than the front panel. The distance between each vertical canal may be the same.

According to a further aspect of the disclosure, an accessory for a vehicle includes a grab handle assembly including a plurality of attachment straps for selectively attaching to a portion of a vehicle. A handle is coupled between the plurality of attachment straps. The handle is adapted to hang freely between the plurality of attachment straps.

In one embodiment, a coupler is provided for selectively connecting the handle to the plurality of attachment straps. The coupler may comprise a first magnet coupled to the plurality of attachment straps and a second magnet coupled to the handle. A fastener may also be provided for attaching an object to the grab handle assembly.

According to yet another aspect of the disclosure, an accessory for a wheel carried by a vehicle is provided. The accessory comprises a cover adapted for covering the vehicle wheel. The cover includes a face having a plurality of vertical canals, and a plurality of cross members coupled to the face and extending across the plurality of vertical canals.

In one embodiment, the accessory further comprises a tread covering portion extending about a circumference of the face. A plurality of attachment loops are coupled to the tread covering portion. A gap may separate first and second portions of the tread covering portion, and a connector may be provided for connecting the first and second portions.

This disclosure also pertains to a method of employing a MOLLE system on a surface of a storage receptacle. The method comprises forming a plurality of vertical canals in a front panel of the storage receptacle. The method further comprises attaching a plurality of cross members to the front panel that intersect the plurality of vertical canals to form a grid. The method still further comprises attaching a rear panel to the front panel by a hinge.

In one embodiment, the method includes forming a plurality of depressions in the front panel that intersect the plurality of vertical canals, and positioning the plurality of cross members in the plurality of depressions. The forming step comprises forming the plurality of depressions at a depth that is less than a depth of the vertical canals. Attaching the plurality of cross members comprises positioning a plurality of external cross members in the plurality of depressions on an external surface of the front panel, positioning a plurality of internal cross members on an internal surface of the front panel, and attaching the external cross members and internal cross members to the front panel.

The method may also comprise forming a pair of channels and a plurality of protrusions in the rear panel, the pair of channels being positioned between adjacent pairs of the plurality of protrusions. The method may include attaching attachment members to at least one of the pair of channels and the plurality of protrusions, and attaching a closure to a periphery of the front panel and a periphery of the rear panel. The closure may comprise a coupler coupled to the periphery of the front panel and a receiver coupled to the periphery of the rear panel, the coupler being receivable by the receiver to selectively couple the front panel to the rear panel.

Also provided is a method of employing a MOLLE system on a surface of a wheel cover. The method includes forming a plurality of vertical canals in the wheel cover. The method further includes attaching a plurality of cross members to the wheel cover that intersect the plurality of vertical canals to form a grid. Still further, the method may include securing the wheel cover to a vehicle wheel.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1A schematically depicts a front perspective view of a storage receptacle comprising a hard-shell Modular Lightweight Load-carrying Equipment (MOLLE) system, according to one or more embodiments shown and described herein;

FIG. 1B schematically depicts a rear perspective view of the MOLLE system of FIG. 1A, according to one or more embodiments shown and described herein;

FIG. 2 schematically depicts various views of the MOLLE system of FIG. 1A, according to one or more embodiments shown and described herein;

FIG. 3 schematically depicts various views of the MOLLE system of FIG. 1A, according to one or more embodiments shown and described herein;

FIG. 4 schematically depicts various views of a front panel of the MOLLE system of FIG. 1A, according to one or more embodiments shown and described herein;

FIG. 5 schematically depicts various views of the MOLLE system of FIG. 1A, according to one or more embodiments shown and described herein;

FIG. 6 schematically depicts various views of the MOLLE system of FIG. 1A, according to one or more embodiments shown and described herein;

FIG. 7 schematically depicts various views of a rear panel of the MOLLE system of FIG. 1A, according to one or more embodiments shown and described herein;

FIG. 8 schematically depicts a rear view of the MOLLE system of FIG. 1A, according to one or more embodiments shown and described herein;

FIG. 9 schematically depicts various views of the MOLLE system of FIG. 1A, according to one or more embodiments shown and described herein;

FIG. 10 schematically depicts a perspective view of a vehicle headliner including the MOLLE system of FIG. 1, according to one or more embodiments shown and described herein;

FIG. 11 depicts a flowchart for a method of forming the MOLLE system of FIG. 1A, according to one or more embodiments shown and described herein;

FIG. 12 schematically depicts a perspective view of a grab handle assembly in a detached position, according to one or more embodiments shown and described herein;

FIG. 13 schematically depicts a perspective view of the grab handle assembly of FIG. 12 in an attached position, according to one or more embodiments shown and described herein;

FIGS. 14 and 15 schematically depict perspective views of the grab handle assembly of FIG. 13 having a fastener for fastening an object, according to one or more embodiments shown and described herein;

FIG. 16 schematically depicts a front perspective view of a storage receptacle in the form of a wheel cover having a MOLLE system, according to one or more embodiments shown and described herein; and

FIG. 17 schematically depicts a rear perspective view of the wheel cover of FIG. 16, according to one or more embodiments shown and described herein.

### DETAILED DESCRIPTION

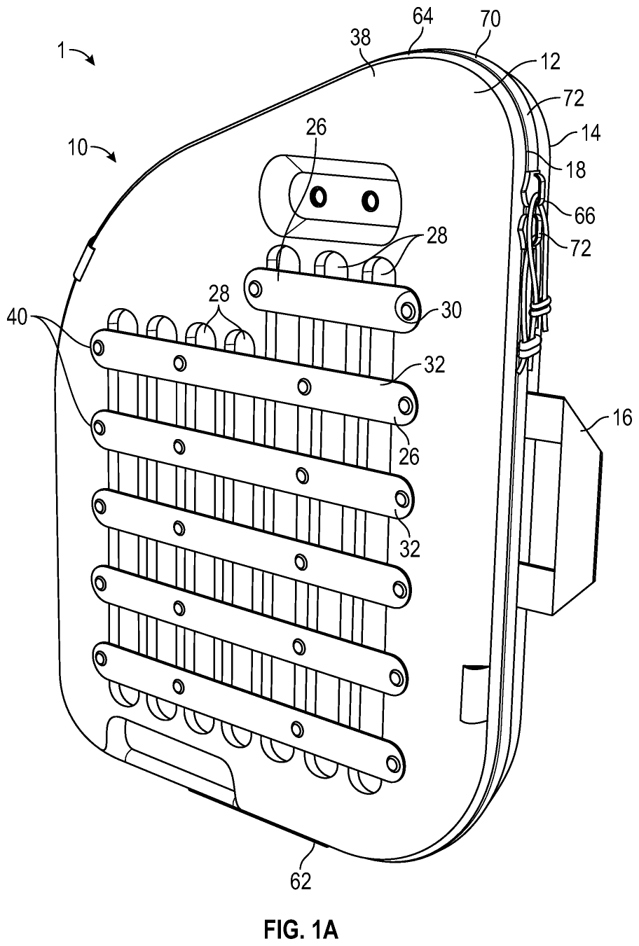

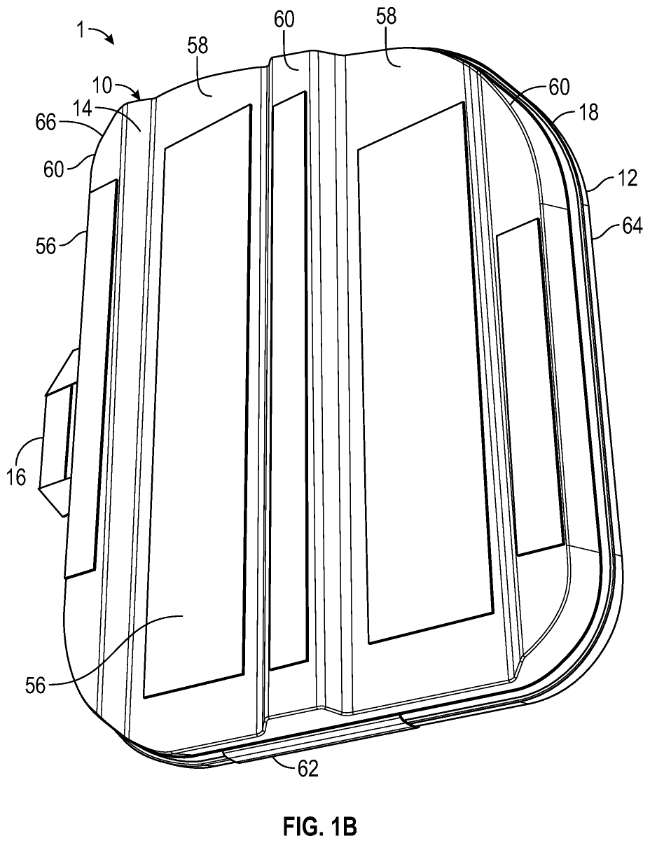

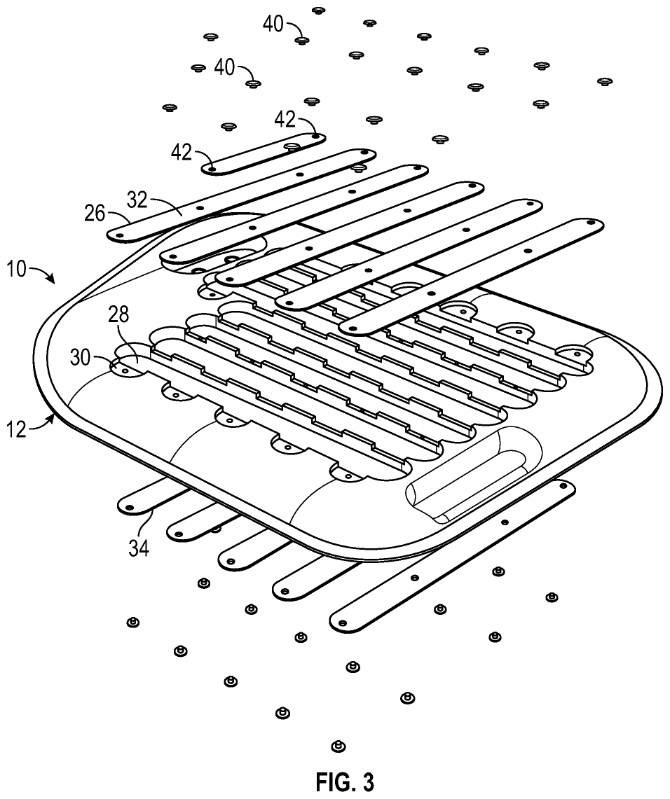

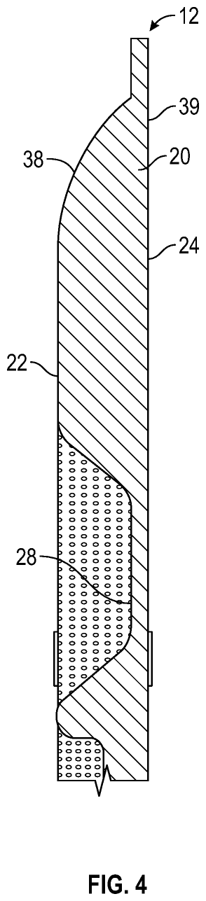

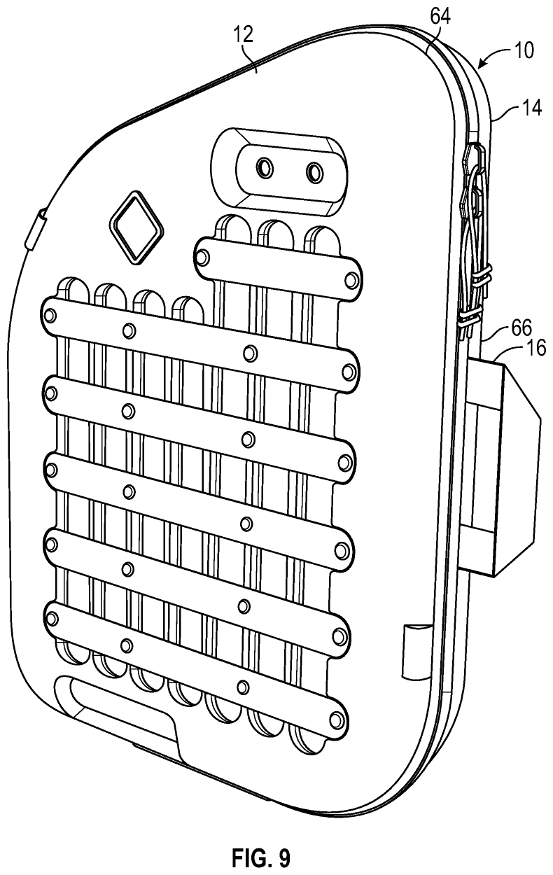

Referring initially to FIGS. 1-10, embodiments of the present disclosure generally relate to a hard-shell Modular Lightweight Load-carrying Equipment (MOLLE) system 1 and related manufacturing methods. The system 1 may comprise a storage receptacle 10 for storing items, while providing a rigid construction to prevent deformation of the storage receptacle 10. The depicted storage receptacle is a clamshell arrangement, however, it is contemplated that the storage receptacle may be any traditional storage receptacle, such as, for example, a backpack, a shoulder bag, or the like. The storage receptacle 10 may also be employed in conjunction with a vehicle, such as by being attached to a vehicle headliner.

Referring now to FIGS. 1A-10, the storage receptacle 10 in one embodiment may include a front panel 12, a rear panel 14, a handle 16, and a closure 18. The handle 16 may be coupled to one of the front panel 12 and/or the rear panel 14 to allow a user to carry the storage receptacle 10. The front panel 12 may include a core 20, an exterior lining 22, an internal lining 24, and a plurality of cross members 26. The core 20 may define a plurality of vertical canals 28, wherein distance between each vertical canal 28 and its adjacent vertical canal 28 is the same. The core 20 may define a plurality of depressions 30 sized and shaped to receive the plurality of cross members 26.

The plurality of depressions 30 may extend generally in parallel, and generally perpendicular to the vertical canals 28. The depressions 30 thus intersect each of the vertical canals 28. The depth of the plurality of molded depressions 30 may be less than depth of the plurality of vertical canals 28 so a space is created between the vertical canals 28 and the cross members 26. Each of the internal lining 24 and the external lining 22 may be coupled to the core 20 to enclose and act as a sheath for the core.

Referring to FIGS. 1A, 3, 5, and 6, the number of vertical canals 28 and cross members 26 may vary depending on the design and/or the surface size of the front panel 12, and thus is not limited to 7 by 6 grid as shown by the figures. For example, the receptacle 10 may include three vertical canals 28 with six cross members 26 (i.e., 3 by 6 grid), or six vertical canals 28 with five cross members 26 (i.e., 6 by 5 grid), or any other variation. While the length (i.e., the longer side) of the vertical canals 28 may vary depending on the design, the width of the vertical canal 28 may fall within a particular range of widths, such as between about 24 millimeters (mm) to about 30 mm to optimize performance. Similarly, while the length and thickness of the cross members 26 may vary depending on the design or size of the grid, with the width of the cross member 26 within a range, such as between about 21 mm to about 30 mm.

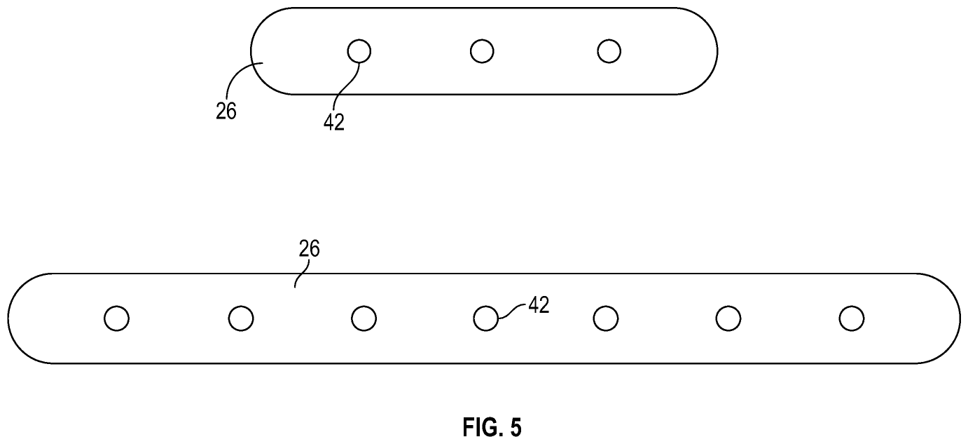

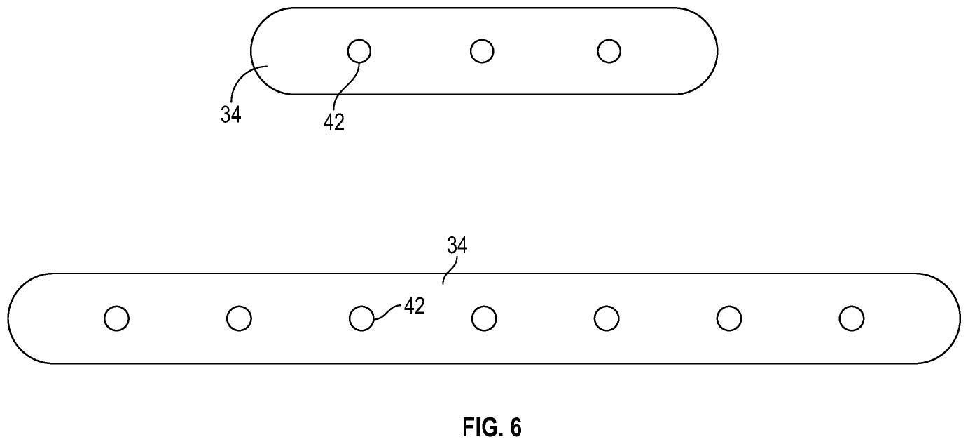

Referring to FIGS. 5 and 6, the plurality of cross members 26 may include a plurality of external cross members 32 and a plurality of internal cross members 34. The plurality of external cross members 32 may be positioned externally to an internal cavity 36, as will be described in further detail herein, to contact an external surface 38 of the front panel 12 and the external lining 22, and be positioned within the plurality of depressions 30. The plurality of internal cross members 34 may be positioned to contact the internal lining 24 and be positioned such that attachment hardware such as fasteners 40 may extend through the external cross members 32 and the internal cross members 34 to sandwich the core 20 and linings 22, 24 between the external cross members 32 and the internal cross members 34.

Referring to FIGS. 1A-3, 5, and 6, the plurality of cross members 26 may further comprise a plurality of holes 42 so they are capable of accepting the attachment hardware and attaching items like lights, knife sheaths and camera equipment like action cameras. The attachment hardware or fasteners 40 may extend through the plurality of holes 42 to couple each of the internal cross members 34, the external cross members 32, and the core 20 together. The fasteners 40 may be any traditional fasteners or connectors for attaching components, including, for example, rivets, screws, bolts, adhesive, epoxy, welding, or the like.

The length for each cross member 26 and/or depression 30 may be configured to be greater than the width of all vertical canals 28 combined, and length for each of the plurality of vertical canals 28 is also configured to exceed the width of all cross members 26 combined. Further, the width of the vertical canal 28 may be within a range of widths, such as between about 24 mm to about 30 mm. Likewise, the width of the cross member 26 may also be within a range, such as between about 21 mm and about 30 mm.

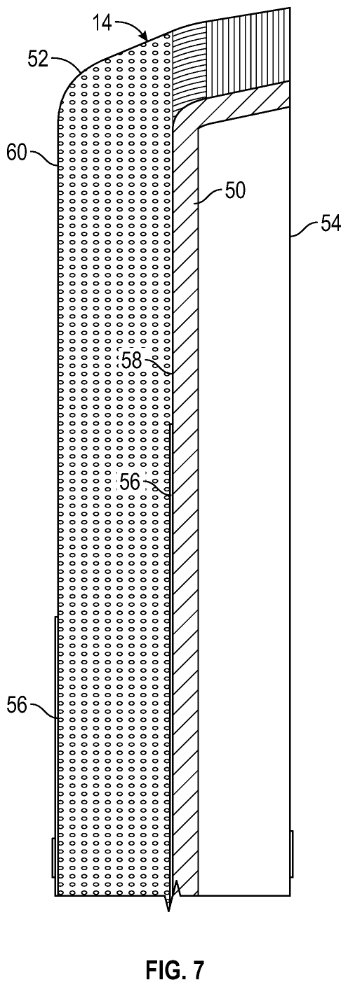

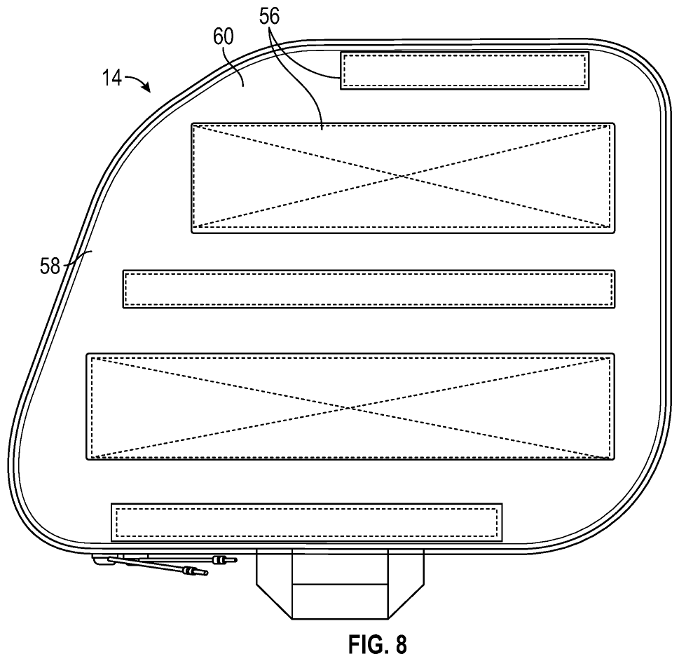

Referring to FIGS. 7 and 8, the rear panel 14 may include a core 50, an exterior lining 52, an internal lining 54, and a plurality of attachment members 56. The core 50 may define a pair of channels 58 wherein distance between each channel 58 and its adjacent channel 58 is the same. The core 50 may define a plurality of protrusions 60 that extend in parallel with the pair of channels 58, each channel 58 being positioned between adjacent pairs of protrusions 60.

Each of the internal lining 54 and the external lining 52 may be coupled to the core 50 to enclose and act as a sheath for the core. The plurality of attachment members 56 may be coupled to the rear panel 14 to facilitate attachment of the rear panel 14 of the system 1 to an external object, such as a vehicle headliner. The attachment members 56 may be coupled to each of the protrusions 60 and the channels 58, and extend along a length of each of the protrusions 60 and the channels 58. The attachment members 56 may be, for example, hook and loop fasteners (e.g., Velcro), buttons, or any other known mechanism for attachment. The attachment members 56 may be coupled to the rear panel 14 by any known method, such as, for example, sewing.

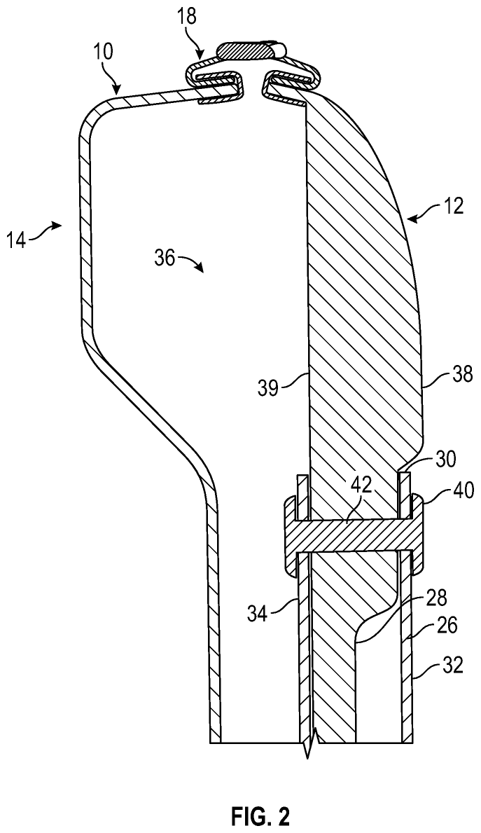

Referring to FIGS. 1 and 2, the front panel 12 may be pivotally coupled to the rear panel 14 by a hinge 62 at a periphery 64, 66 of each of the front panel 12 and the rear panel 14. The front panel 12 may be sewn to the rear panel 14 at a portion of the periphery 64, 66 of each of the front panel 12 and the rear panel 14 to define the hinge 62, where the front panel 12 may pivot relative to the rear panel 14 at the sewn portion of the periphery 64, 66. However, it is contemplated and possible that the hinge 62 may be any other hinge capable of pivoting the front panel 12 relative to the rear panel 14, such as, for example, a piano hinge.

The closure 18 may be coupled along the periphery 64, 66 of each of the front panel 12 and the rear panel 14 to extend from one end of the hinge 62 to the other end of the hinge 62. The closure 18 may selectively couple the front panel 12 to the rear panel 14 along the periphery 64, 66 of each of the front panel 12 and the rear panel 14. When the front panel 12 is coupled to the rear panel 14, the system 1 may define the internal cavity 36 configured to store items.

The closure 18 may include a coupler 70 coupled to the periphery 64 of the front panel 12, and a receiver 72 coupled to the periphery 66 of the rear panel 14. The coupler 70 may be receivable by the receiver 72 to selectively couple the front panel 12 to the rear panel 14. The closure 18 may be, for example, a zipper, where the coupler 70 is a first set of teeth 70 coupled to and extending along the periphery 64 of the front panel 12, and the receiver 72 is a second set of teeth 72 coupled to and extending along the periphery 66 of the rear panel 14, and further includes a slider 74 engaging each set of teeth 70, 72 to be configured to selectively couple the sets of teeth 70, 72 together. It is further contemplated and possible that the closure 18 may be any known closure 18 capable of attaching the front panel 12 to the rear panel 14 along the periphery 64, 66 of each panel 12, 14, such as, for example, buttons.

The panels 12, 14 may comprise the same or similar materials, such as polymers. In one particular version, the rear core 50 of the rear panel 14 is harder or more rigid (“dimensionally stable”) than the front core 20 of the front panel 12. In other words, the front panel 12 may be considered soft or flexible (e.g., fabricated from a soft ethyl vinyl acetate (EVA) foam core 20), and the rear panel 14 may be considered hard or rigid (e.g., fabricated from a hard EVA foam core 50, possibly with a fabric (e.g., CORDURA) covering). For the soft core material, the Shore A hardness may be within a range from about 0 to about 65 (or specifically 20-65), and for the hard core material, the Shore A hardness may be in a range from about 65 to about 100 (or specifically 70-75), but different materials or hardness values could be used depending on the particular circumstances encountered.

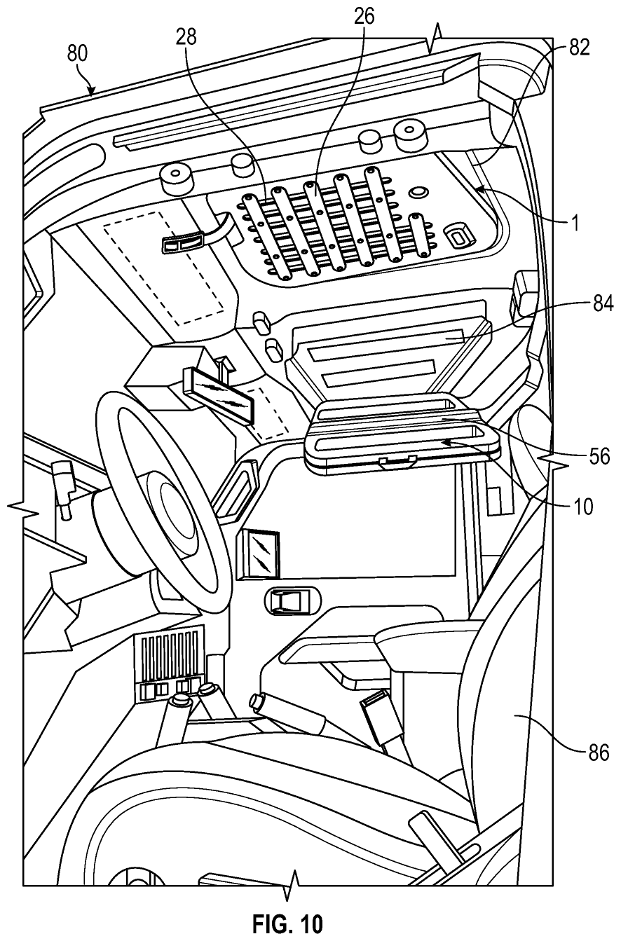

Referring now to FIG. 10, the system 1 is depicted installed in a vehicle 80 and serving as a headliner within an interior compartment thereof. The vehicle 80 may include a liner 82 along a portion thereof, such as the roof or ceiling of the interior compartment. One or more fasteners or attachment members 84 coupled to the liner 82 are configured to selectively attach to the fasteners or attachment members 56 of the storage receptacle 10.

As depicted in FIG. 10, the storage receptacle 10 may be attached to the liner 82 above a seat 86 of the vehicle 80. The seat 86 may be a driver's seat or a passenger seat. It is further contemplated and possible that the system 1 may be formed in the liner 82 of the vehicle 80. For example, the liner 82 may form the plurality of vertical channels 28 that the cross members 26 are coupled thereto.

When attached to the liner 82, the storage receptacle 10 may be opened so that the front panel 12 extends partially across a windshield of the vehicle 80 to act as a sunshade. In embodiments, the storage receptacle 10 may include a plurality of elastic straps (not shown) positioned on the inside of the storage receptacle 10 for retaining the position of objects positioned within the inside of the storage receptacle 10. Objects retained by the elastic straps within the storage receptacle 10 are prevented from falling out of the storage receptacle 10 when opened.

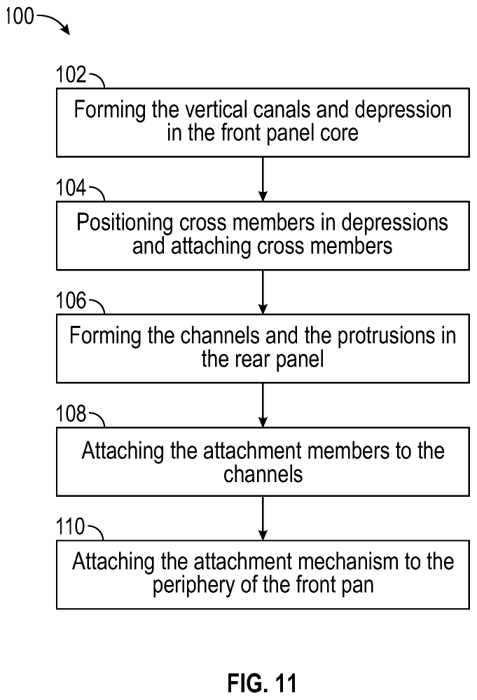

Referring now to FIG. 11, a flowchart of a method 100 of forming the storage receptacle 10 is depicted. At step 102, the method 100 may include forming the plurality of vertical canals 28 and the plurality of depressions 30 in the core 20 of the front panel 12. As discussed above, the plurality of depressions 30 may be formed at a depth that is less than a depth of the vertical canals 28. The vertical canals 28 and the depressions 30 may be formed by thermoforming the core 20 with the vertical canals 28 and the depressions 30.

At step 104, the method 100 may include positioning the plurality of cross members 26 in the plurality of depressions 30 and attaching the plurality of cross members 26 to the front panel 12 by the attachment hardware or fasteners 40 to intersect the plurality of vertical canals 28, thereby forming a grid. Attaching the plurality of cross members 26 may include positioning the plurality of external cross members 32 in the plurality of depressions 30 on an external surface 38 of the front panel 12, positioning the plurality of internal cross members 34 on an internal surface 39 of the front panel 12 opposite the external surface 38, and attaching the external cross members 32 and internal cross members 34 to the front panel 12 by the attachment hardware or fasteners 40.

At step 106, the method 100 may include forming the pair of channels 58 and the protrusions 60 in the rear panel 14. The channels 58 and the protrusions 60 may be formed by thermoforming the core 50 with the channels 58 and the protrusions 60. At step 108, the method 100 may include attaching the attachment members 56 to at least one of the pair of channels 58 and the plurality of protrusions 60. At step 110, the method 100 may include attaching the closure 18 to the periphery 64 of the front panel 12 and the periphery 66 of the rear panel 14. The closure 18 may be attached by any traditional method, such as, for example, sewing, adhesive, fasteners, or the like.

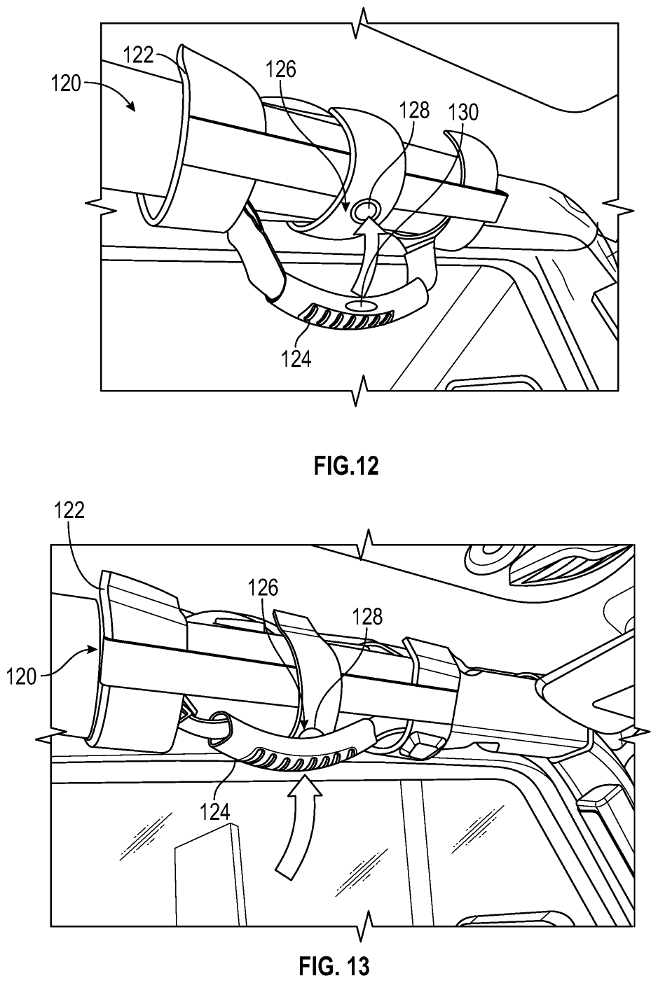

Referring to FIGS. 12-15, a vehicle accessory in the form of a grab handle assembly 120 for a vehicle is depicted. The grab handle assembly 120 may include attachment straps 122 selectively attachable to a portion of the vehicle, such as a roll cage. The attachment straps 122 may include attachment mechanisms, such as hook and loop fasteners, which permit the selective attachment to the portion of the vehicle.

The grab handle assembly 120 may include a handle 124 coupled between a pair of the attachment straps 122 to hang down freely from the vehicle portion to which the assembly is attached. The grab handle assembly 120 includes a connector 126 having a first portion 128 and a second portion 130 for selectively coupling to the first portion 128. The first portion 128 may be attached to the attachment straps 122, and the second portion 130 is attached to the handle 124 to allow the handle 124 to be secured to the attachment straps 122, preventing the handle 124 from freely hanging from the vehicle portion. The connector 126 may be any mechanism for attachment, for example, magnetic, where the first portion 128 and the second portion 130 are both magnets.

As shown in FIG. 12, the grab handle assembly 120 is in a detached position, where the handle 124 is spaced apart from the attachment straps 122 to hang down freely. As shown in FIG. 15, the grab handle assembly 120 is in an attached position with the handle 124 secured to the attachment straps 122 by the connector 126 to be secured to the vehicle portion. By restraining the positioned of the handle 124 against the vehicle portion, the handle 124 is kept out of view during operation of the vehicle, and prevents the handle 124 from impacting a driver's head.

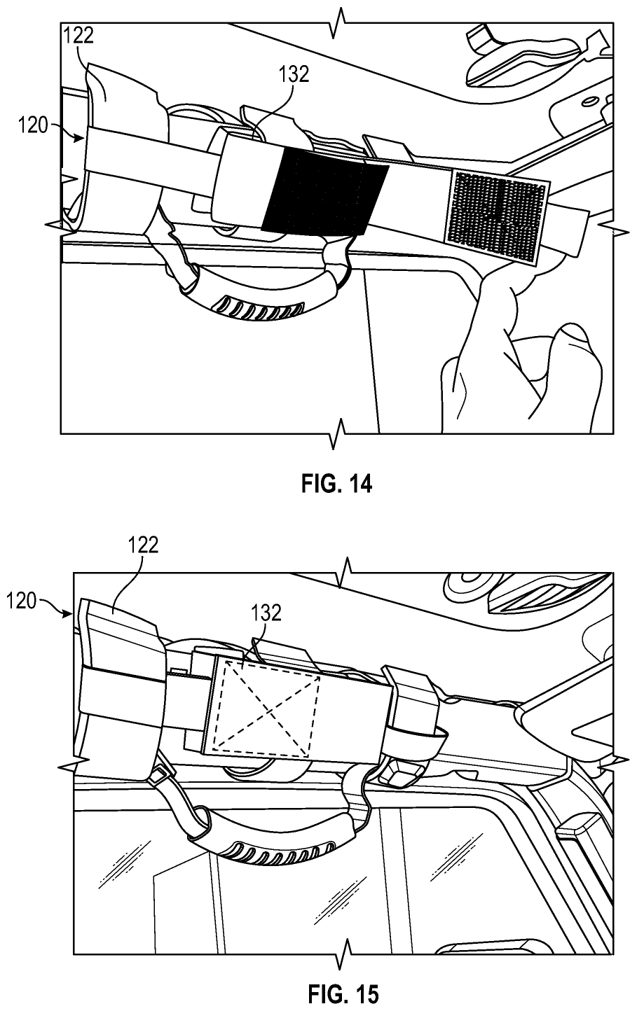

Referring to FIGS. 14 and 15, the grab handle assembly 120 may include a fastener 132 for fastening an object thereto. The object may take any form, such as for example equipment including seatbelt cutters, knives, flash lights, tourniquets, or the like. The fastener 132 may be a layered hook and loop strap that folds or rolls up to secure the object in place.

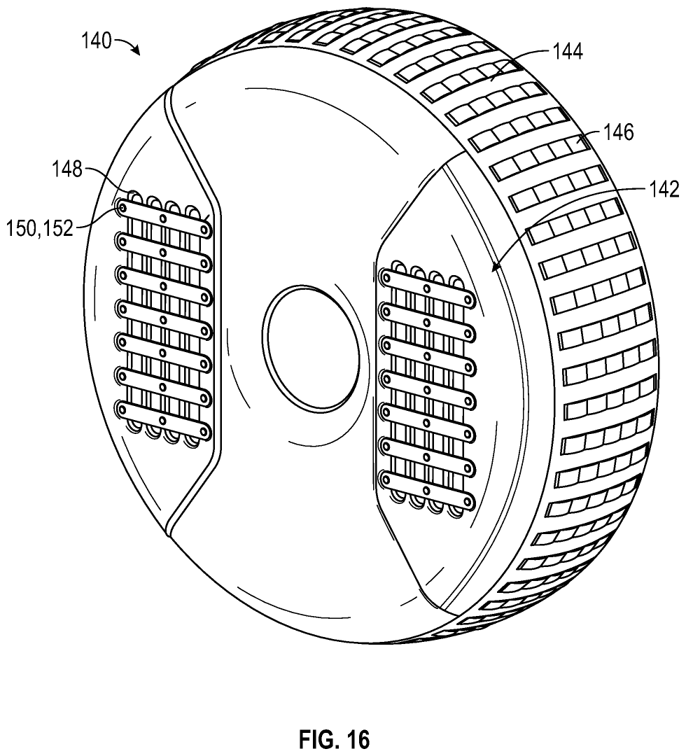

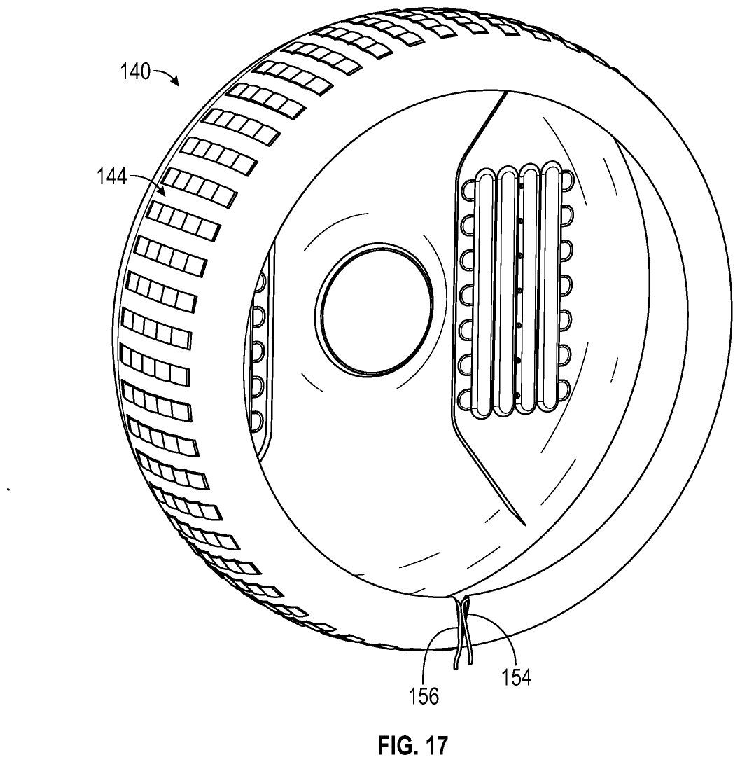

Referring to FIGS. 16 and 17, another storage receptacle for use as a vehicle accessory in the form of a wheel cover 140 is depicted. The wheel cover 140 may incorporate a MOLLE system similar to that described above. The wheel cover 140 includes a face 142 and a tread covering portion 144 extending around a circumference of the face 142. When positioned around a wheel, the face 142 covers a rim of the wheel and the tread covering portion 144 covers tread of the wheel.

A connector may also be provided for connecting with one or more objects. For example, a plurality of attachment loops 146 may be coupled to the tread covering portion 144 along the entire circumference of the tread covering portion 144. The attachment loops 146 may be configured to couple objects to the wheel cover 140, such as, for example, one or more carabiners.

The face 142 may define a plurality of vertical canals 148, and a plurality of depressions 150 may be formed therein. The depressions 150 may be sized and shaped to receive a plurality of cross members 152 that extend generally perpendicular to and across the vertical canals 148. The vertical canals 148, the depressions 150, and the cross members 152 are similar to the vertical canals 28, the depressions 30, and the cross members 26 described above, and like structure will not be described again for brevity. As depicted in FIGS. 16 and 17, the wheel cover 140 may include two sets of the vertical canals 148, depressions 150, and cross members 152 positioned on opposing sides of a center of the wheel cover 140.

Referring specifically to FIG. 17, the wheel cover 140 may also include a cut or gap 154 separating the wheel cover 140. This gap 154 allows for first and second portions of the wheel cover 140 to separate and receive the vehicle wheel, which may include a hub and a tire. A connector such as a cinch or string 156 may be positioned at the gap 154 for closing it when the wheel cover 140 is attached to the wheel.

Summarizing, this disclosure may related to any or all of the foregoing items:
1. A storage receptacle for storing one or more objects in a vehicle, comprising:
   a front panel including:
   a front core defining a plurality of vertical canals extending generally in parallel;
   a plurality of cross members coupled to the front core and intersecting the plurality of vertical canals to form a grid;
   a rear panel connected to the front panel by a hinge and movable from an open condition to a closed condition forming an internal cavity for receiving the one or more objects; and
   a closure for securing the front panel to the rear panel to retain the one or more objects in the internal cavity in the closed position.
2. The storage receptacle of item 1, wherein the rear panel comprises a rear core defining a pair of channels and a plurality of protrusions, the pair of channels being positioned between adjacent pairs of the plurality of protrusions.
3. The storage receptacle of item 1 or item 2, wherein the rear panel further comprises fasteners for securing the storage receptacle to a portion of the vehicle.
4. The storage receptacle of any of items 1-3, wherein the front core further defines a plurality of depressions that intersect the plurality of vertical canals, the plurality of cross members being positioned within the plurality of depressions.
5. The storage receptacle of item 4, wherein the plurality of depressions have a depth that is less than a depth of the vertical canals.
6. The storage receptacle of any of items 1-5, wherein the plurality of cross members comprise a plurality of external cross members connected to an external surface of the front panel, and a plurality of internal cross members coupled to an internal surface of the front panel.
7. The storage receptacle of item 6, wherein the internal cross members are positioned on the internal surface such that fasteners may extend through the external cross members, the front core, and the internal cross members to couple each of the external cross members, the front core, and the internal cross members together.
8. The storage receptacle of any of items 1-7, wherein the closure comprises a coupler coupled to a periphery of the front panel and a receiver coupled to a periphery of the rear panel, the coupler adapted to be received by the receiver to selectively secure the front panel to the rear panel.
9. The storage receptacle of item 8, wherein the closure is a zipper.
10. The storage receptacle of any of items 1-9, further comprising a handle coupled to one of the front panel and the rear panel.
11. The storage receptacle of any of items 1-10, wherein a length for each cross member greater than a width of all vertical canals combined, and a length for each of the plurality of vertical canals is greater than a width of all cross members combined.
12. The storage receptacle of any of items 1-11, wherein the rear panel is harder than the front panel.
13. The storage receptacle of item 12, wherein a distance between each vertical canal is the same.
14. A vehicle headliner comprising the storage receptacle of any of items 1-13.
15. A vehicle including an interior roof, comprising:
   a headliner adapted for storing one or more objects, and
   a connector for removably connecting the headliner to the interior roof of the vehicle.
16. The vehicle of item 15, wherein the headliner includes a plurality of vertical canals extending generally in parallel, and a plurality of cross members coupled to the headliner, the plurality of cross members intersecting the plurality of vertical canals to form a grid.
17. The vehicle of item 15 or item 16, wherein the headliner comprises:
   a front panel including the plurality of vertical canals;
   a front core coupled to the plurality of cross members; and
   a rear panel pivotally coupled to the front panel by a hinge, the rear panel configured to be selectively coupled to the front panel to define an internal cavity.
18. The vehicle of any of items 15-17, wherein the rear panel comprises a rear core defining a pair of channels and a plurality of protrusions, the pair of channels being positioned between adjacent pairs of the plurality of protrusions.
19. The vehicle of item 18, wherein the connector is located on at least one of the pair of channels and the plurality of protrusions.
20. The vehicle of any of items 17-19, wherein the front core further defines a plurality of depressions that intersect the plurality of vertical canals, the plurality of cross members being positioned within the plurality of depressions.
21. The vehicle of item 20, wherein the plurality of depressions have a depth that is less than a depth of the vertical canals.
22. The vehicle of any of items 17-21, wherein the plurality of cross members comprise a plurality of external cross members coupled to an external surface of the front panel, and a plurality of internal cross members coupled to an internal surface of the front panel.
23. The vehicle of item 22, wherein the internal cross members are positioned on the internal surface such that fasteners may extend through the external cross members, the front core, and the internal cross members to couple each of the external cross members, the front core, and the internal cross members together.
24. The vehicle of any of items 17-23, further comprising a closure comprising a coupler coupled to a periphery of the front panel and a receiver coupled to a periphery of the rear panel, the coupler is receivable by the receiver to selectively couple the front panel to the rear panel.
25. The vehicle of item 24, wherein the closure is a zipper.
26. The vehicle of any of items 17-25, further comprising a handle coupled to one of the front panel and the rear panel.
27. The vehicle of any of items 17-26, wherein a length for each cross member greater than a width of all vertical canals combined, and a length for each of the plurality of vertical canals is greater than a width of all cross members combined.
28. The vehicle of any of items 17-26, wherein the rear panel is harder than the front panel.
29. The vehicle of any of items 16-28, wherein a distance between each vertical canal is the same.
30. An accessory for a vehicle, comprising:
   a grab handle assembly including a plurality of attachment straps for selectively attaching to a portion of a vehicle; and
   a handle coupled between the plurality of attachment straps, the handle adapted to hang freely between the plurality of attachment straps.
31. The accessory according to item 30, further including a coupler for selectively connecting the handle to the plurality of attachment straps.
32. The accessory according to item 30 or item 31, wherein the coupler comprises a first magnet coupled to the plurality of attachment straps and a second magnet coupled to the handle.
33. The accessory of any of items 30-33, further comprising a fastener for attaching an object.
34. A vehicle including the accessory of any of items 30-33.
35. An accessory for a wheel carried by a vehicle, comprising:
   a cover adapted for covering the vehicle wheel, the cover including a face having a plurality of vertical canals, and a plurality of cross members coupled to the face and extending across the plurality of vertical canals.
36. The accessory of item 35, further comprising:
   a tread covering portion extending about a circumference of the face; and
   a plurality of attachment loops coupled to the tread covering portion.
37. The accessory of item 35 or item 36, further including a gap separating first and second portions of the tread covering portion.
38. The accessory of any of items 35-37, further including a connector for connecting the first and second portions.
39. A vehicle including the accessory of any of items 35-38.
40. A method of employing a MOLLE system on a surface of a storage receptacle, comprising:
   forming a plurality of vertical canals in a front panel of the storage receptacle;
   attaching a plurality of cross members to the front panel that intersect the plurality of vertical canals to form a grid; and
   attaching a rear panel to the front panel by a hinge.
41. The method of item 40, further comprising forming a plurality of depressions in the front panel that intersect the plurality of vertical canals, and positioning the plurality of cross members in the plurality of depressions.
42. The method of item 40 or item 41, wherein the forming step comprises forming the plurality of depressions at a depth that is less than a depth of the vertical canals.
43. The method of item 40 or item 41, wherein attaching the plurality of cross members comprises:
   positioning a plurality of external cross members in the plurality of depressions on an external surface of the front panel,
   positioning a plurality of internal cross members on an internal surface of the front panel, and
   attaching the external cross members and internal cross members to the front panel.
44. The method of any of items 40-43, further comprising forming a pair of channels and a plurality of protrusions in the rear panel, the pair of channels being positioned between adjacent pairs of the plurality of protrusions.
45. The method of any of items 40-44, further comprising attaching connectors to at least one of the pair of channels and the plurality of protrusions.
46. The method of any of items 40-45, further comprising attaching a closure a periphery of the front panel and a periphery of the rear panel, the closure comprising a coupler coupled to the periphery of the front panel and a receiver coupled to the periphery of the rear panel, the coupler being receivable by the receiver to selectively couple the front panel to the rear panel.
47. A method of employing a MOLLE system on a surface of a wheel cover, comprising:
   forming a plurality of vertical canals in the wheel cover; and
   attaching a plurality of cross members to the wheel cover that intersect the plurality of vertical canals to form a grid.
48. The method of item 47, further including the step of securing the wheel cover to a vehicle wheel.

It is noted that the terms “generally”, “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

It will be apparent to those skilled in the art that various modifications and variations can be made to the embodiments described herein without departing from the scope of the claimed subject matter. Thus, it is intended that the specification cover the modifications and variations of the various embodiments described herein provided such modification and variations come within the scope of the appended claims and their equivalents.

1. A storage receptacle for storing one or more objects in a vehicle, comprising:
a front panel including:
a front core defining a plurality of vertical canals extending generally in parallel;
a plurality of cross members coupled to the front core and intersecting the plurality of vertical canals to form a grid;
a rear panel connected to the front panel by a hinge and movable from an open condition to a closed condition forming an internal cavity for receiving the one or more objects; and
a closure for securing the front panel to the rear panel to retain the one or more objects in the internal cavity in the closed position.

2. The storage receptacle of claim 1, wherein the rear panel comprises a rear core defining a pair of channels and a plurality of protrusions, the pair of channels being positioned between adjacent pairs of the plurality of protrusions.

3. The storage receptacle of claim 1, wherein the rear panel further comprises fasteners for securing the storage receptacle to a portion of the vehicle.

4. The storage receptacle of claim 1, wherein the front core further defines a plurality of depressions that intersect the plurality of vertical canals, the plurality of cross members being positioned within the plurality of depressions.

5. The storage receptacle of claim 4, wherein the plurality of depressions have a depth that is less than a depth of the vertical canals.

6. The storage receptacle of claim 1, wherein the plurality of cross members comprise a plurality of external cross members connected to an external surface of the front panel, and a plurality of internal cross members coupled to an internal surface of the front panel.

7. The storage receptacle of claim 6, wherein the internal cross members are positioned on the internal surface such that fasteners may extend through the external cross members, the front core, and the internal cross members to couple each of the external cross members, the front core, and the internal cross members together.

8. The storage receptacle of claim 1, wherein the closure comprises a coupler coupled to a periphery of the front panel and a receiver coupled to a periphery of the rear panel, the coupler adapted to be received by the receiver to selectively secure the front panel to the rear panel.

9. The storage receptacle of claim 8, wherein the closure is a zipper.

10. The storage receptacle of claim 1, further comprising a handle coupled to one of the front panel and the rear panel.

11. The storage receptacle of claim 1, wherein a length for each cross member greater than a width of all vertical canals combined, and a length for each of the plurality of vertical canals is greater than a width of all cross members combined.

12. The storage receptacle of claim 1, wherein the rear panel is harder than the front panel.

13. The storage receptacle of claim 12, wherein a distance between each vertical canal is the same.

14. A vehicle headliner comprising the storage receptacle of claim 1.

15. A vehicle including an interior roof, comprising:
a headliner adapted for storing one or more objects, and
a connector for removably connecting the headliner to the interior roof of the vehicle.

16. The vehicle of claim 15, wherein the headliner includes a plurality of vertical canals extending generally in parallel, and a plurality of cross members coupled to the headliner, the plurality of cross members intersecting the plurality of vertical canals to form a grid.

17. The vehicle of claim 16, wherein the headliner comprises:
a front panel including the plurality of vertical canals;
a front core coupled to the plurality of cross members; and
a rear panel pivotally coupled to the front panel by a hinge, the rear panel configured to be selectively coupled to the front panel to define an internal cavity.

18. The vehicle of claim 17, wherein the rear panel comprises a rear core defining a pair of channels and a plurality of protrusions, the pair of channels being positioned between adjacent pairs of the plurality of protrusions.

19. The vehicle of claim 18, wherein the connector is located on at least one of the pair of channels and the plurality of protrusions.

20. The vehicle of claim 17, wherein the front core further defines a plurality of depressions that intersect the plurality of vertical canals, the plurality of cross members being positioned within the plurality of depressions.

21.-47. (canceled)
